(19) United States
(12) Patent Application Publication
(10) Pub. No.: US 2006/0132835 A1
(43) Pub. Date: Jun. 22, 2006

(54) Application interface for device driver settings

(76) Inventor: Prasad Nagaraja, Concord, CA (US)

Correspondence Address: Kyocera Technology Development;Intellectual Property Administration, Suite 400, 1855 Gateway Blvd., Concord, CA, 94520, US

(21) Appl. No.: 11/017,105

(22) Filed: Dec. 17, 2004

(51) Int. Cl. G06F 3/12

(52) U.S. Cl. 358/1.15; 358/1.13

(57) ABSTRACT

A method for communicating device settings from an application to a device driver, by storing the settings in a temporary file, and communicating the temporary file's name to the device driver. Application programming interfaces (APIs) of programming languages often provide access to only a subset of device settings. Fore example, Java and C APIs may provide access to the common printer (public devmode) settings but not to the optional and printer-model-specific (private devmode) settings. The method enables communication of device settings not included in the APIs. Methods include use of Java Native Interface call, encoding a temporary file name in a job name, unique identification string in a job name, unique file names supporting simultaneous, multiple jobs, and modularization by a user interface package and a communication interface package.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to device drivers, and more particularly to an application interface for device driver settings.

### BACKGROUND OF THE INVENTION

Device drivers are generally known, including a printer driver. Typically, printing from a computer occurs through the use of a printer driver. Upon either an application launch or during a print command load time, the application will call an instance of the printer driver and provide the user with an interface to set the desired printer driver settings. Printer driver settings may also be called printer options, print settings, driver options, printer parameters, print selections, etc. The printer driver settings specify preferences on features of the printer.

Application programming interfaces (APIs) of programming languages often provide access to only a subset of printer settings. More specifically, programming languages such as C, Java, J++ and Visual Basic, often provide access to the common printer settings (public devmode settings) but not to the optional and printer-model-specific settings (private devmode settings). There is need for a more general way of communicating printer settings from an application to a printer driver.

The present invention arose out of the above concerns associated with providing an improved application interface for device driver settings.

### SUMMARY OF THE INVENTION

Methods, computer program products, computing and printing systems for providing an improved application interface for device driver settings. Presented is a method for communicating device settings from an application to a device driver, by storing the settings in a temporary file, and communicating the temporary file's name to the device driver. Application programming interfaces (APIs) of programming languages often provide access to only a subset of device settings. Fore example, Java and C APIs may provide access to the common printer (public devmode) settings but not to the optional and printer-model-specific (private devmode) settings. The method enables communication of device settings not included in the APIs. Methods include use of Java Native Interface call, encoding a temporary file name in a job name, unique identification string in a job name, unique file names supporting simultaneous, multiple jobs, and modularization by a user interface package and a communication interface package.

The invention will be more fully understood upon consideration of the detailed description below, taken together with the accompanying drawings.

### DESCRIPTION OF THE DRAWINGS

FIG. 1 is a simplified block diagram showing connection of a computing system to a printer.

FIG. 2 is a block diagram of an exemplary computing system employing principles of the invention.

FIG. 3 is a flowchart showing processing on the application side, in accordance with a preferred embodiment of the present invention.

FIG. 4 is a flowchart showing processing on the device driver side, in accordance with a preferred embodiment of the present invention.

FIG. 5 is a view of the encoding of the temporary file name and other information in a job name, in accordance with a preferred embodiment of the present invention.

FIG. 6 is a block diagram of an exemplary computing system with a user interface package and a communication package employing principles of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

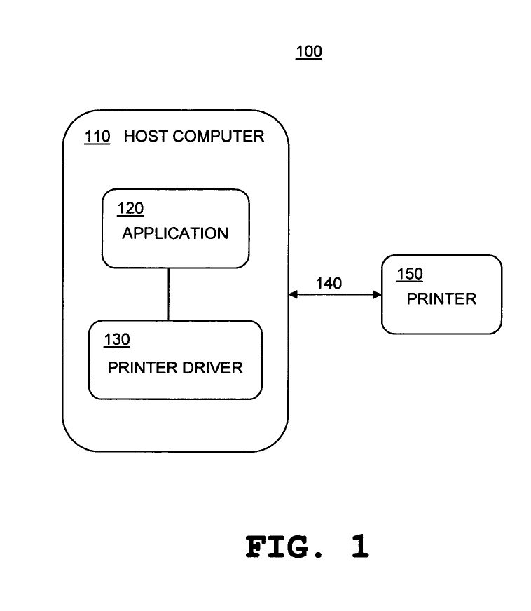

FIG. 1 shows a general printing system setup 100 that includes a host computer 110 and a printer 150. Here, the printer 150 may be any device that can act as a printer, e.g. an inkjet printer, a laser printer, a photo printer, or an MFP (Multifunction Peripheral or Multi-Functional Peripheral) that may incorporate additional functions such as faxing, facsimile transmission, scanning, and copying.

The host computer 110 includes an application 120 and a printer driver 130. The application 120 refers to any computer program that is capable of issuing any type of request, either directly or indirectly, to print information. Examples of an application include, but are not limited to, commonly used programs such as word processors, spreadsheets, browsers and imaging programs. Since the invention is not platform or machine specific, other examples of application 120 include any program written for any device, including personal computers, network appliance, handheld computer, personal digital assistant, handheld or multimedia devices that is capable of printing.

The printer driver 130 is a software interfacing with the application 120 and the printer 150. Printer drivers are generally known. They enable a processor, such as a personal computer, to configure an output data from an application that will be recognized and acted upon by a connected printer. The output data stream implements necessary synchronizing actions required to enable interaction between the processor and the connected printer. For a processor, such as a personal computer, to operate correctly, it requires an operating system such as DOS (Disk Operating System) Windows, Unix, Linux, Palm OS, or Apple OS.

A printer I/O (Input/Output) interface connection 140 is provided and permits host computer 110 to communicate with a printer 150. Printer 150 is configured to receive print commands from the host computer and, responsive thereto, render a printed media. Various exemplary printers include laser printers that are sold by the assignee of this invention. The connection 140 from the host computer 110 to the printer 150 may be a traditional printer cable through a parallel interface connection or any other method of connecting a computer to a printer used in the art, e.g., a serial interface connection, a remote network connection, a wireless connection, or an infrared connection. The varieties of processors, printing systems, and connection between them are well known.

The present invention is suited for printer driver settings, and it is also suited for other device drivers. The above explanations regarding FIG. 1 used a printer driver rather than a general device driver for concreteness of the explanations, but they also apply to other device drivers. Similarly, the following descriptions of the preferred embodiments generally use examples pertaining to printer driver settings, but they are to be understood as similarly applicable to other kinds of device drivers.

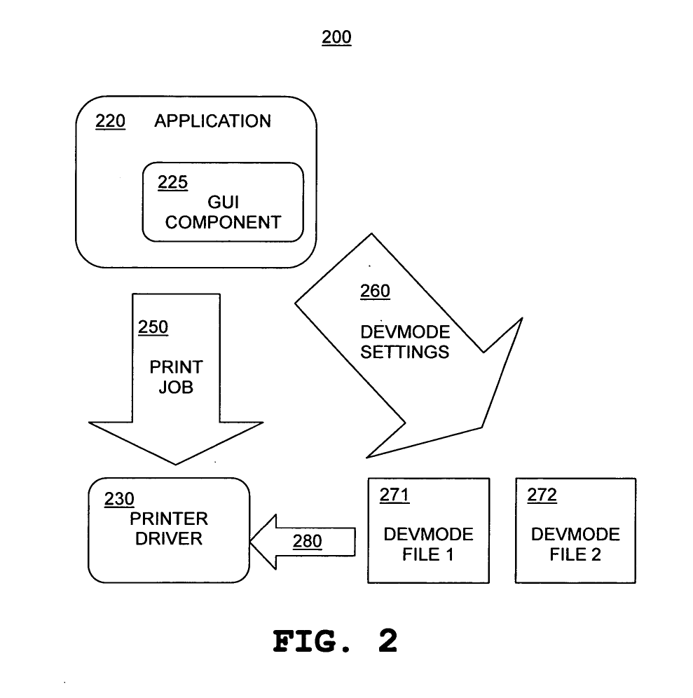

FIG. 2 is a block diagram of an exemplary computing system employing principles of the invention. Methods of the present invention are used to communicate printer driver settings from an application to a printer driver. This system 200 illustrates the interaction between an application 220 and a printer driver 230, and how they communicate using the devmode files 271, 272. The data flows in the system are shown as 250, 260 and 280. Although not shown, it will be apparent to one of ordinary skill in the art that the computing system 200 may include multiple applications and printer drivers running on one or more operating systems. Furthermore, the system 200 may be connected to multiple printers.

A devmode data structure contains information about the device initialization and configuration of documents in the printer. Settings for features that are common to all or most printers are stored in the public devmode, whereas settings for features that are optional and printer-model-specific are stored in the private devmode. Use of the methods in the present invention is necessary if the computer language for implementing the application provides no API for accessing the private devmode. Some print jobs do not require any settings to be specified using the private devmode. Even if this is the case, it may be of advantage to use one of the methods in the present invention in the interest of uniformity, generality, data-redundancy or other concerns.

After the user optionally changes the devmode settings using the GUI component 225, the user initiates a print job from the application 220, typically by clicking on an OK or PRINT button on the GUI. This causes two actions to be taken. First, in the application side, devmode settings 260 are saved and stored in a devmode file1 271 which is a temporary file. Second, a print job 250 is initiated.

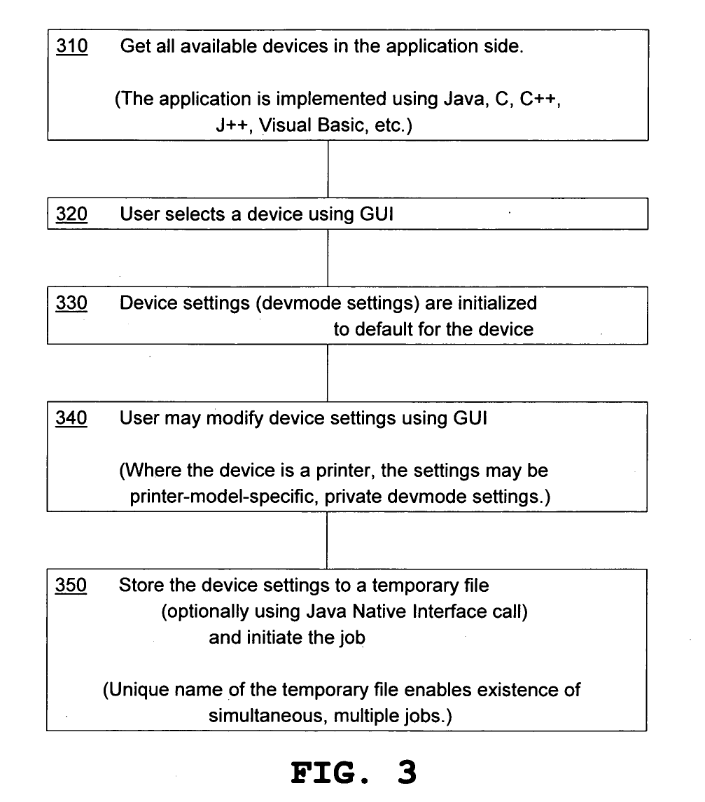

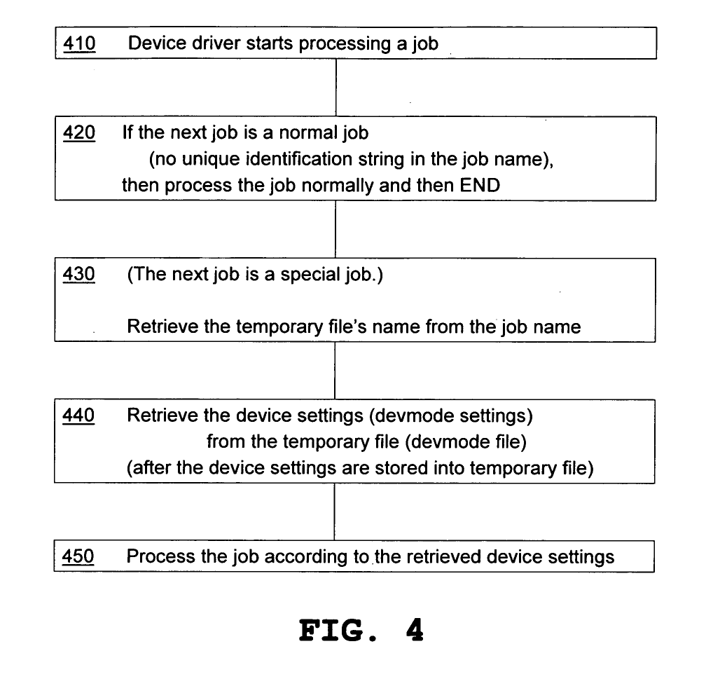

A special print job is a print job that requires or employs the methods of the present invention, whereas those jobs that do not employ the special processing of the present invention are called normal print jobs. When the printer driver 230 is ready to print the print job 250, it recognizes that it is a special print job. How this recognition is made is described below. The driver then retrieves the devmode settings 280 corresponding the print job from the devmode file1 271 corresponding to the print job 250. The details of how this correspondence is made and recognized by the printer driver will be as shown in FIG. 3 and FIG. 4 and described in detail below.

A new print job can be initiated without waiting for the completion of a previous print job. The second set of devmode settings is written and stored into a new devmode file2 272 with a different name. Unique names of the temporary files 271, 272 and the association between the jobs and the temporary files enables existence of simultaneous, multiple jobs.

FIG. 3 is a flowchart showing processing on the application side, in accordance with a preferred embodiment of the present invention. In an embodiment of the present invention, the application is implemented using programming languages such as Java, C, C++, J++, Visual Basic, etc. In step 310, a list of all available printers is received by the application side. This step and the next step 320 can be omitted if there is a previously chosen printer and it is assumed that the same printer is to be used again for the current printing job. Then in step 320 the user selects the printer to be used for the print job using GUI. In step 330, device settings (or devmode settings) are initialized to default for the selected printer. In step 340, the user may modify the devmode settings using the GUI component. As described earlier, where the device is a printer, the settings may be printer-model-specific, private devmode settings.

In step 350, when the user is satisfied with the print settings, the user initiates the print job, typically by clicking on an OK or PRINT button of the GUI. This causes two actions to be taken. First, in the application side, devmode settings are saved and stored in a devmode file, which is a temporary file. Second, a print job is initiated. In an embodiment of the present invention, storing of the device settings to a temporary file comprises using a Java Native Interface call. Unique names of the temporary files and the association between the jobs and the temporary files enables existence of simultaneous, multiple jobs.

FIG. 4 is a flowchart showing processing on the device driver side, in accordance with a preferred embodiment of the present invention. FIG. 4 illustrates the steps performed by the printer driver, in conjunction with the steps to be performed on the application side.

In step 410, the printer driver obtains the next print job to be processed, and starts processing it. In step 420, the printer driver determines whether the print job obtained in step 410 is a special print job. In one embodiment of the present invention, this is achieved by including a special tag, such as ###DEVMODE_IN_FILE###, in the job name of a special print job. A job name is a part of standard Windows printing interface. If the job name does not contain the special tag, the print job is a normal print job. The special tag needs to be chosen carefully so that a normal print job would never contain the special tag in the job name. If the next print job is a normal job (not a special print job), the job is printed in a normal way, without any special processing disclosed in this invention, and the processing of the next job described in FIG. 4 ends.

If, however, the printer driver determines that the print job obtained in step 410 is a special print job, the printer driver proceeds to step 430. In step 430, the printer driver retrieves the temporary file's name from the job name. In one embodiment of this invention, this is achieved by including the file name in a job name. In step 440, the device settings (devmode settings) are retrieved from the temporary file (devmode file), whose name was retrieved in the previous step. In an embodiment of the present invention, this retrieval occurs after the device settings are stored into the temporary file, or in other words, the storing of the device settings into the temporary file is ensured to precede the device driver's retrieval. In step 450, the print job is printed according to the setting retrieved from the devmode file in the previous step.

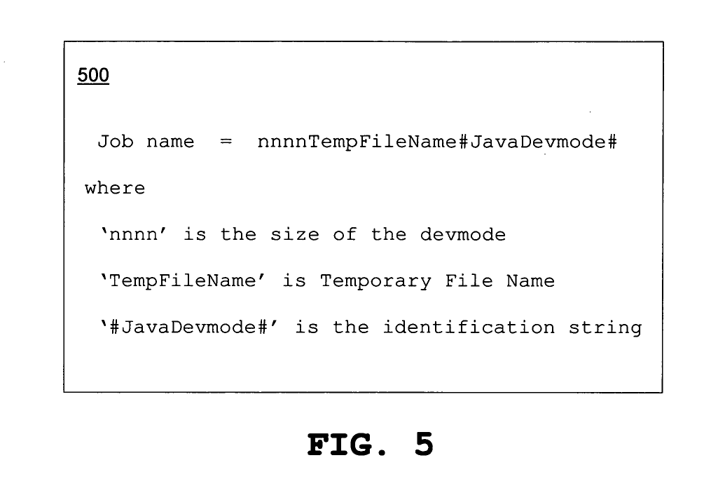

FIG. 5 is a view of the encoding of the temporary file name and other information in a job name, in accordance with a preferred embodiment of the present invention. A job name is a part of standard Windows printing interface. Here, three pieces of information are encoded in a job name. In the job name “nnnn” is the size of the devmode, typically in bytes, to assist in the retrieval process. “TempFileName” is the temporary file's name. #JavaDevmode# is the identification string to be recognized by the printer driver. The special tag needs to be chosen carefully so that a normal print job would never contain the special tag in the job name.

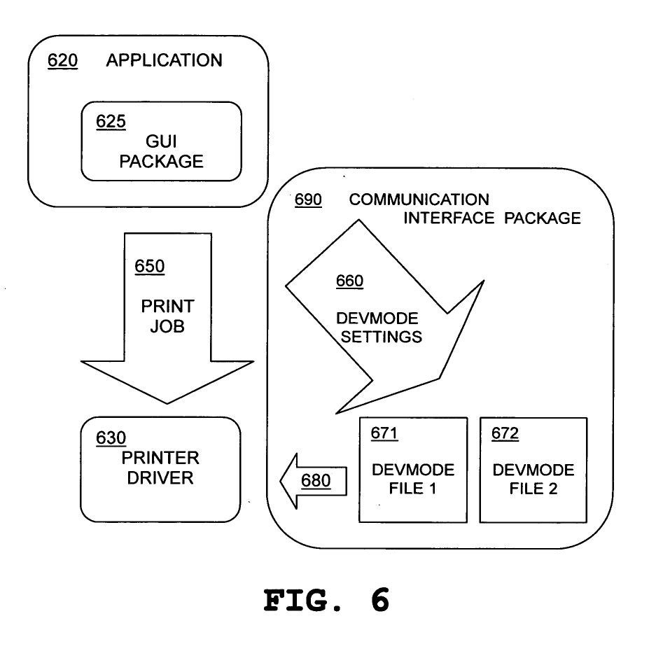

FIG. 6 is a block diagram of an exemplary computing system with a user interface package and a communication package employing principles of the invention. Methods of the present invention are used to communicate printer driver settings from an application to a printer driver. As in FIG. 2, this system illustrates the interaction between an application 620 and a printer driver 630, and how they communicate using the devmode files 671, 672. The data flows in the system are shown as 650, 660 and 680. Although not shown, it will be apparent to one of ordinary skill in the art that the computing system may include multiple applications and printer drivers running on one or more operating systems. Furthermore, the system may be connected to multiple printers.

In FIG. 6 the GUI component of FIG. 2 is replaced by a GUI package 625 and the dataflows 660, 680 and devmode files 671, 672 are encapsulated in a communication interface package 690. The communication interface package 690 encapsulates the mechanism of how the device settings are stored in temporary files, which is distinct from the mechanism of communication from an application to a printer driver without the methods of the present invention. The GUI package 625 and the communication interface package 690 modularizes the functionality of the communication mechanisms of the present invention to enable any application and any printer driver to use the methods of the present invention as long as the application and the printer driver accommodate the interface defined by the GUI package 625 and the communication interface package 690.

Although this invention has been largely described using terminology pertaining to printer drivers, one skilled in this art could see how the disclosed methods can be used with other device drivers. The foregoing descriptions used printer drivers rather than general device drivers for concreteness of the explanations, but they also apply to other device drivers. Similarly, the foregoing descriptions of the preferred embodiments generally use examples pertaining to printer driver settings, but they are to be understood as similarly applicable to other kinds of device drivers.

Although this invention has been largely described using Windows terminology, one skilled in this art could see how the disclosed methods can be used with other operating systems, such as DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A method for communicating at least one device setting from an application to a device driver, comprising: storing the at least one device setting into a temporary file; and communicating the temporary file's name to the device driver.

2. The method of claim 1, wherein the at least one printer setting comprises a printer-model-specific, private devmode setting.

3. The method of claim 1, wherein the application is implemented using a computer language selected from the group consisting of Java, C, C++, J++, and Visual Basic.

4. The method of claim 1, wherein the storing of the at least one device setting into a temporary file comprises a Java Native Interface call.

5. The method of claim 1, wherein the communicating of the at least one device setting is modularized by a user interface package and a communication interface package.

6. The method of claim 1, wherein the communicating of the temporary file's name to the printer driver comprises encoding the file name in a job name.

7. The method of claim 6, wherein the job name comprises a unique identification string recognized by the device driver.

8. The method of claim 7, wherein the storing of the at least one device setting into the temporary file precedes the device driver's retrieval of the at least one device setting in the temporary file, and wherein unique names of the temporary file enables existence of simultaneous, multiple jobs.

9. A computer program product for communicating at least one device setting from an application to a device driver, comprising machine-readable code for causing a machine to perform the method steps of: storing the at least one device setting into a temporary file; and communicating the temporary file's name to the device driver.

10. The computer program product of claim 9, wherein the at least one printer setting comprises a printer-model-specific, private devmode setting.

11. The computer program product of claim 9, wherein the application is implemented using a computer language selected from the group consisting of Java, C, C++, J++, and Visual Basic, and wherein the storing of the at least one device setting into a temporary file comprises a Java Native Interface call.

12. The computer program product of claim 9, wherein the communicating of the at least one device setting is modularized by a user interface package and a communication interface package.

13. The computer program product of claim 9, wherein the communicating of the temporary file's name to the printer driver comprises encoding the file name in a job name, and wherein the job name comprises a unique identification string recognized by the device driver.

14. The computer program product of claim 13, wherein the storing of the at least one device setting into the temporary file precedes the device driver's retrieval of the at least one device setting in the temporary file, and wherein unique names of the temporary file enables existence of simultaneous, multiple jobs.

15. A computing system, comprising a device driver, programmed to communicate at least one device setting from an application to a device driver, comprising: storing the at least one device setting into a temporary file; and communicating the temporary file's name to the device driver.

16. The computing system of claim 15, further comprising a print engine, wherein the at least one printer setting comprises a printer-model-specific, private devmode setting.

17. The computing system of claim 15, wherein the application is implemented using a computer language selected from the group consisting of Java, C, C++, J++, and Visual Basic, and wherein the storing of the at least one device setting into a temporary file comprises a Java Native Interface call.

18. The computing system of claim 15, wherein the communicating of the at least one device setting is modularized by a user interface package and a communication interface package.

19. The computing system of claim 15, wherein the communicating of the temporary file's name to the printer driver comprises encoding the file name in a job name, and wherein the job name comprises a unique identification string recognized by the device driver.

20. The computing system of claim 19, wherein the storing of the at least one device setting into the temporary file precedes the device driver's retrieval of the at least one device setting in the temporary file, and wherein unique names of the temporary file enables existence of simultaneous, multiple jobs.
